(19) United States
(12) Patent Application Publication
(10) Pub. No.: US 2003/0210684 A1
(43) Pub. Date: Nov. 13, 2003

(54) Packet transceiving method and device

(75) Inventors: Jiin Lai, Hsin Tien City (TW); Patrick Lin, Hsin Tien City (TW)

Correspondence Address: ARENT FOX KINTNER PLOTKIN & KAHN, PLLC, Suite 400, 1050 Connecticut Avenue, N.W., Washington, DC, 20036-5339, US

(73) Assignee: VIA TECHNOLOGIES, INC.

(21) Appl. No.: 10/422,968

(22) Filed: Apr. 25, 2003

(30) Foreign Application Priority Data
May 7, 2002 (TW) 91109483

(51) Int. Cl. H04Q 11/00

(52) U.S. Cl. 370/381; 370/392

(57) ABSTRACT

This invention is an implementation of a host channel adapter and method for transferring packet data over a network. When packets are distributed by a packet-switching system, a control unit and a plurality of header buffers allow the packet transmission to be carried out efficiently in executing the actions of reading and moving the packets. This reduces repetitions in reading and moving the packets, which enables the host channel adapter to use the bandwidth of the memory efficiently through the help of the control unit.

### BACKGROUND OF THE INVENTION

1. Field of the Invention

This present invention relates to a method and device for transceiving data packets via a communication network, and more specifically to a host channel adapter (HCA) and a method therefore that utilizes a plurality of header buffers and a control unit to enhance the efficiency of packet transceiving.

2. Description of the Prior Art

Under a data communication network environment, the host channel adapter (HCA) is used to receive packet information transmitted by peripheral devices to the packet-switching network. The information is then transferred to memory connected with a CPU. The hardware module within the HCA supports various interfaces by using static random access memory (SRAM) as packet buffer for packet-switching and storage between the host lines interface and the network. As packets transmitted by the physical layer transfers from the HCA to the host memory, packets are temporarily stored in SRAM and read by dynamic random access memory (DRAM) later. Since the bandwidth of SRAM is shared by direct access memory and transceiving links, repeated memory accessing between SRAM and DRAM will increase the time in reading and moving the packet data and further affect the overall transmission process.

Therefore, an object of the present invention is to provide a HCA and a method for efficient processing of packet headers during packet-switching by using a plurality of header buffers under a multi-port transmission network.

Another object of the present invention is to provide a HCA and a method for dynamic management of packet transceiving under a multi-port transmission network.

### SUMMARY OF THE INVENTION

In prior arts, repeated memory accessing between SRAM and DRAM during packet-switching will not only increase the time in reading and moving the packet data but also affect the overall transmission process. This results in a low level of system load efficiency. Moreover, even SRAM and DRAM are replaced by other higher speed memories, the defects induced by repeated memory accessing still are unavoidable.

The present invention provides a HCA and a packet transceiving method under multi-port transmission network. The method for receiving packet is implemented in a HCA of a packet-switching system. The HCA enables the connection of CPU to InfiniBand fabric network. The packet transceiving method includes the following steps: storing received packets in memory (such as SRAM); copying packet headers into header buffers in HCA, waiting for local processor (such as receiving processor) to process the packet headers; and transmitting packet headers of unprocessed packets in memory header into buffers when the header buffers are not full.

In one of the preferred embodiments of the present invention, a HCA is implemented in a packet-switching system, which enables the connection of CPU to the InfiniBand fabric network. The HCA supports Multi-port PHY interface, a SRAM interface, a DRAM interface and a processor interface. The HCA includes header buffers for temporary storage of packet headers. The header buffers increase the speed of the processor in dealing with packet loading. The HCA also includes a control unit for monitoring the load transceiving of the header buffers and controlling that headers of unprocessed packets are stored in unfull (which means empty or partially full) header buffers. This allows the HCA to dynamically adjust the mechanism of packet transceiving which leads to an optimal load transceiving and efficient packet receiving.

The advantages and features of the HCA device and its relevant method are further explained in the following detailed descriptions and figures.

### BRIEF DESCRIPTION OF THE DRAWINGS

FIG. 1 is a block diagram of the host channel adapter (HCA) packet receiving device according to the prior art.

FIG. 2 is a block diagram of packet receiving according to a preferred embodiment of the present invention.

FIG. 3 is the block diagram of packet receiving according to another preferred embodiment of the present invention.

FIG. 4 is a block diagram of packet receiving according to the other preferred embodiment of the present invention.

FIG. 5 is a state mechanism table of packet header transmission.

FIG. 6 is a state mechanism table of the control unit in dynamic management.

FIG. 7 is a schematic diagram of the implementation in packet receiving according to the present invention.

FIG. 8 is a circuit diagram of packet receiving control unit according to the present invention.

FIG. 9 is a state diagram of packet receiving control unit according to the present invention.

### REFERENCE NUMERALS DESCRIPTION

1—Host channel adapter (HCA)

2—Physical layer device

3—Static random access memory (SRAM)

4—Dynamic random access memory (DRAM)

5—Read selector

7—Receiving processor

8—Transmitting processor

9—Header buffers

10—Control unit

101—IDLE

102—FIFO ACT

103—FIFO FULL

104—BUF2 FIFO

105—BUF FULL

### DETAILED DESCRIPTION OF THE INVENTION

Although some preferred embodiments are given in detailed description with appropriate figures, it will be apparent to those skilled in the art that the implementation may be altered in many ways without departing from the scope of the invention. Further, the scope of the invention should be only decided by the following claims.

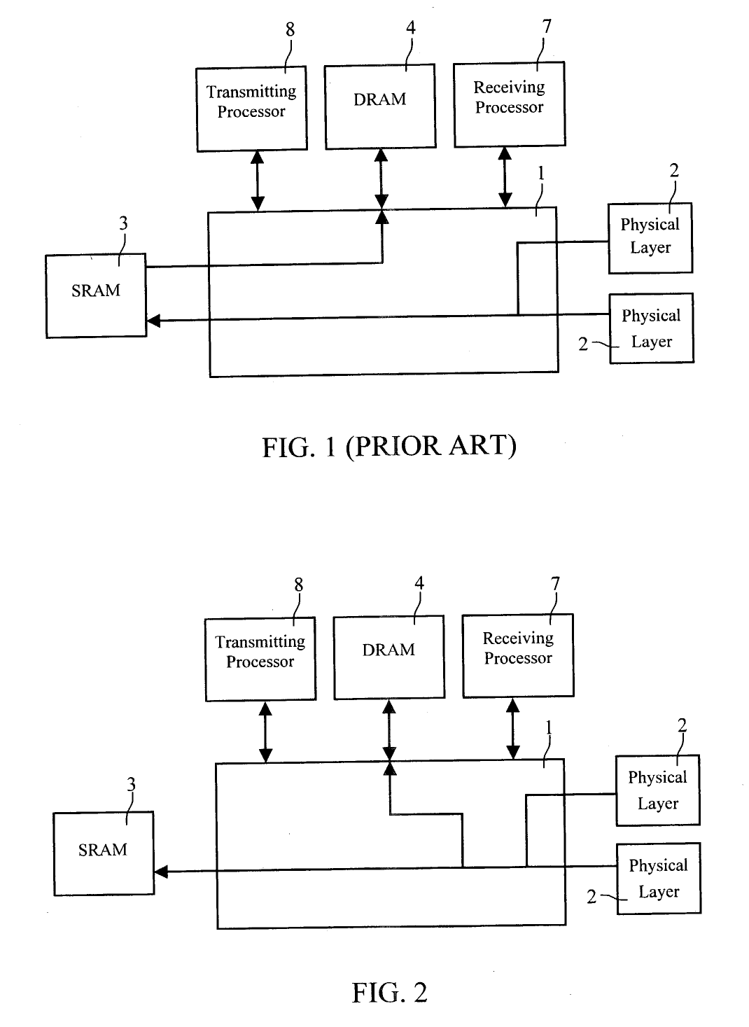

Please refer to FIG. 1 which illustrates a block diagram of a HCA (1) in packet receiving. The hardware module in the HCA (1) supports two-port or multi-port PHY interface that receives packets from the physical layer device. The SRAM interface is coupled to a DRAM (3) and is used for packet-switching and storage between a host lines interface and a network. The processor interface is coupled to a receiving processor (7) and a transmitting processor (8) for managing packet receiving and transmission. The DRAM interface is coupled to a DRAM (4) which is shared by the receiving processor (7) and the transmitting processor (8). Thence, the HCA (1) makes use of the high-speed feature of SRAM as data buffers.

Continuing from FIG. 1, the hardware module in the HCA (1) consists of multiple DMA engines. The DMA engines controlled by the local processor handle data transmission between SRAM (3) and DRAM (4). Each physical layer port has two corresponding hardware engines, one for transmission and another for receiving. The functionality of the HCA (1), as an example, is to enable the connection of the host CPU to the InfiniBand fabric network.

The packet transceiving device and method are mainly used in the environment of InfiniBand fabric network. The InfiniBand fabric network covers the first physical layer, second data link layer, third network layer, and fourth transport layer in the protocol of the seven layer OSI (open system interconnect) reference model. The purpose is to completely remove complex I/O data streams and signal distribution/exchange from the server and replace it with a node to node management. This reduces the required resource and eliminates the repetitions in decoding, encoding, and parsing of packet headers on many medium/large internet servers or clustered system operations. The result leads to a more efficient and faster internet service. InfiniBand fabric network performs one-to-one or one-to-many I/O access management by using the node to node management. Some of the nodes can be defined as subnets and authorized to control any information streams and configurations below. From the specifications, InfiniBand fabric network can achieve a speed of 2.5 Gbps with a single node, 10 Gbps with four nodes, and theoretically 30 Gbps with a maximum of twelve nodes. InfiniBand fabric network consists of internal crossbar switch architecture that supports cut-through switching. It can be used in copper wire and optical fiber medians. The supported products and applications range from server, switch, router, interface card, to end-point manager software . . . etc.

Please refer to FIG. 2 in conjunction with FIG. 1 for the block diagram of an embodiment herein. The packet receiving device and method are used to resolve the increase of packet access between SRAM (3) and DRAM (4) when the receiving processor (7) performs packet transceiving after the HCA receives the packets in FIG. 1. FIG. 2 depicts the novel architecture of the present invention: at least the pocket headers of the packets are copied to DRAM(4) while the packets are appeared on the PHY interface and received by the HCA(1). Therefore, when the receiving processor (7) performs data access, the number of accesses to the SRAM (3) can be effectively reduced for the existence of the packet headers (or even other portions of the packets).

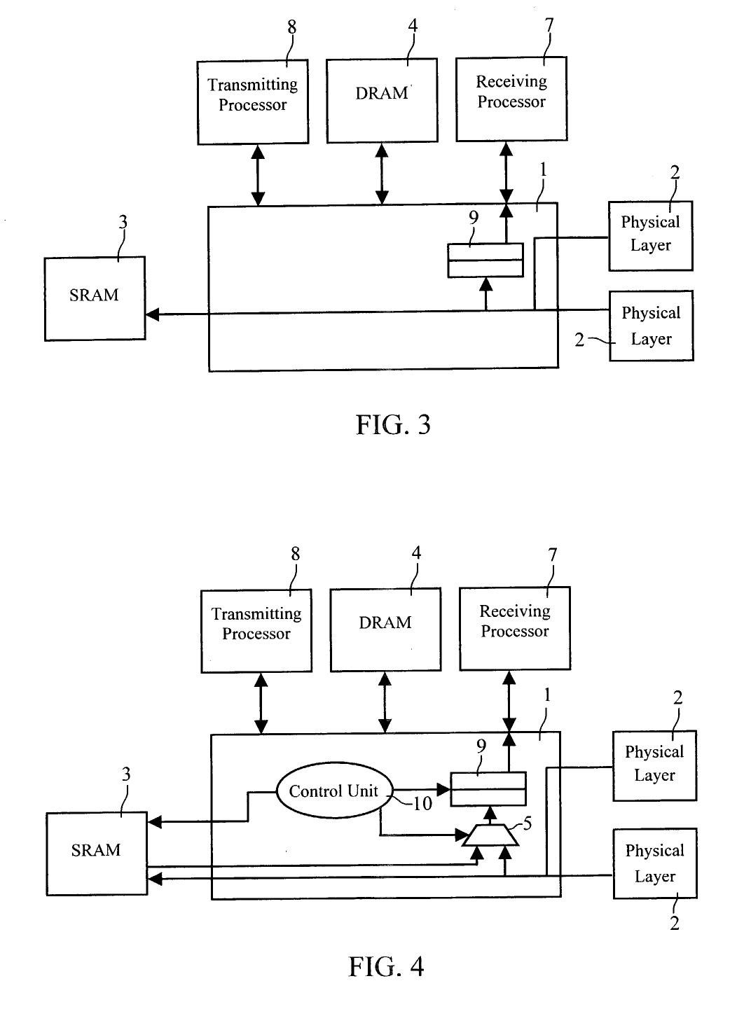

Please refer to FIG. 3 in conjunction with FIG. 2 for the block diagram of another preferred embodiment herein. As shown by the architecture in FIG. 2, the HCA (1) has several (two in this implementation) header buffers (9) for temporary storage of packet headers in order to increase the load transceiving speed of the processor. When a packet arrives, the HCA (1) will duplicate the header of the packet and store it in priority to the header buffers (9). This provides fast transceiving of the receiving processor (7) through packet access of the processor interface. At the same time, the packet will be saved temporarily in SRAM (3). Moreover, once the header buffers (9) are full, new packet headers will only be stored in DRAM. The hardware architecture of the header buffers (9) can be static random access units, latches, or flip-flops... etc. Moreover, only packet headers need to be stored, which requires very little space and therefore the executing speed is fast. This will prevent the receiving processor (7) from taking up the bandwidth of SRAM (3) when accessing packet headers. Hence, the overall packet transceiving efficiency is increased.

Please refer to FIG. 4 in conjunction with FIG. 3 for the block diagram of the other preferred embodiment herein. In order to solve the problem that occurs when the header buffers are full in FIG. 3, a control unit (10) can be used. This control unit (1) is able to dynamically manage the packet headers received by the header buffers (9). When the header buffers (9) have a space after the receiving processor (7) fetching packet headers, the control unit (1) will automatically signal the SRAM (3) and temporarily store headers of unprocessed packets from the SRAM (3) into the header buffers (9). This allows the receiving processor (7) to process the packets in an efficient and timely fashion through dynamic management of the header buffers by the control unit (10).

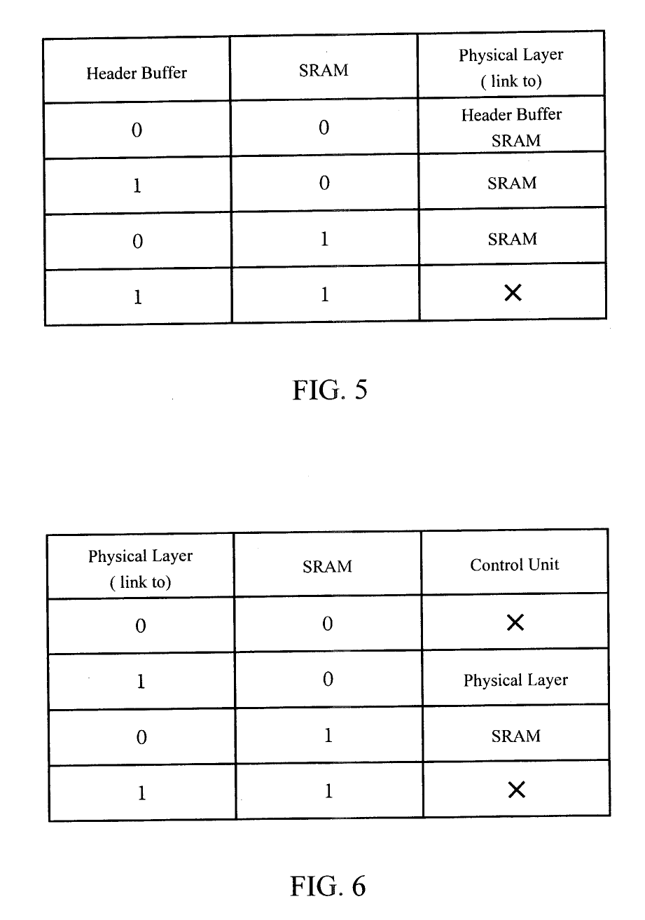

Please refer to FIG. 5 in conjunction with FIG. 4 for a state mechanism table of the packet header transmission herein. When packets enter the HCA (1) from the physical layer device (2), there are four kinds of status. The first status, labeled as 0 in FIG. 5, is when both the header buffers (9) and the SRAM are empty. Received packets will be stored temporarily in both the header buffers (9) and the SRAM (3). The second status, labeled as 1 in FIG. 5, is when only the header buffers (9) are full. In this case, packet headers will not longer be sent to the header buffers (9) but stored in the SRAM (3) directly. The third status is when the header buffers (9) become unfull after transceiving previously stored packet headers. Unprocessed packet headers stored in SRAM (3) will be processed in priority because the header buffers (9) were previously full. Therefore, in order to maintain the sequence, when new packets arrive, they will be sent to SRAM (3) only. The last status occurs when both the header buffers (3) and SRAM (3) are full. Received packets will be discarded in this case.

In short, for the prior arts, because packets have different lengths, they need to be completely stored in SRAM (3) before the headers can be fetched and processed. Apparently, this occupies a certain amount of bandwidth from SRAM (3). In contrast, for this invention, a plurality of header buffers can be used to store and directly provide the headers for fetching and processing. Hence, the present invention effectively overcomes the problem of storing packets completely in SRAM (3) before they can be processed.

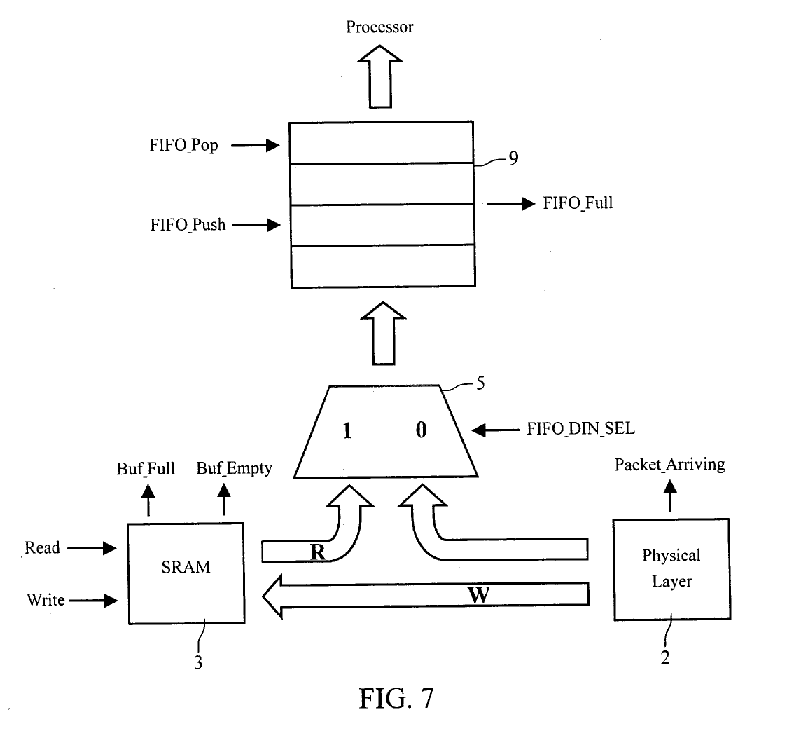

Please refer to FIG. 6 in conjunction with FIG. 4 and FIG. 5 for a state mechanism table of the control unit in dynamic management of packets. Under different conditions, the header buffers (9) can access packet headers from the physical layer device (2) or SRAM (3). The first status is when the physical layer device (2) has not received any packets and the SRAM (3) has no packets. In this case, the control unit (10) is idle. The second status occurs when the physical layer device (2) starts to receive packets and the SRAM (3) does not need to process packets in priority because of the header buffers (9) are not full. In this case, the control unit (10) allows packet headers from the physical layer device (2) to be stored directly into the header buffers (9). The third status is when the header buffers were previously full and unprocessed packets still reside in SRAM (3). Now that the header buffers (9) are unfull, the control unit (10) will automatically send the unprocessed packet headers from the SRAM (3) to the header buffers (9). The last status is when both the header buffers (9) and the SRAM (3) are full. The control unit (10) will not signal the SRAM (3) to fetch new packet headers and instead the packets are discarded. Please refer to FIG. 7 in conjunction with FIG. 4 for an illustration of transmission and related signals between the header buffers, the SRAM, and the physical layer. Each header buffer usually has a FIFO architecture. When the receiving processor (7) reads packet headers, the header buffers (9) will send its packet headers received in priority to the receiving processor (7). The header buffers (9) can be static random access units, latches, flip-flops or other memory. For example, the header buffers (9) can receive FIFO_Pop and FIFO_Push signals for executing the pop actions of reading packet headers and the push action of writing packet headers, respectively. The buffers will also output a FIFO_Full signal when header buffers (9) are full. The control unit (10) manages the source of packet headers received by the header buffers (9) through a read selector (5) which is responsible for selecting packet headers from either the SRAM (3) or the physical layer device (2).

At the beginning, when packets enter the physical layer device (2), the control unit (10) stores the packet headers temporarily in the header buffers (9). Meanwhile, packet data is stored temporarily in SRAM (3). At this time, the read selector (5) enables the packet headers to be transferred from the physical layer device (2) to the header buffers (9). When the header buffers (9) become full, the control unit (1) no long sends packet headers to the buffers but directly to the SRAM (3). After the header buffers (9) finish transceiving previous packet headers, the read selector (5) will access in priority the packet headers sent to the SRAM (3) because the header buffers were previously full. Packets received afterwards will be sent to the SRAM (3) in order to maintain a transceiving sequence. When both the header buffers (9) and the SRAM (3) are full, the packets will be dropped.

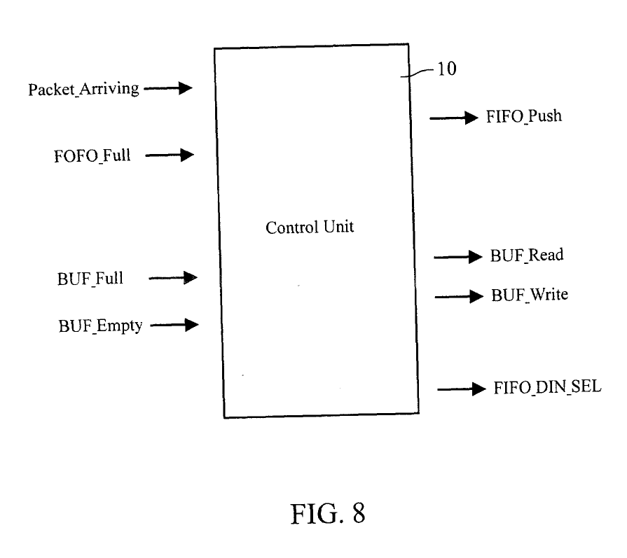

Please refer to FIG. 8 in conjunction with FIG. 7 for a circuit diagram of the control unit. Besides FIFO_Full and FIFO_Push signals to the header buffers (9), the control unit (10) also receives a Packet_Arriving signal to the physical layer device (2) for indicating packets have arrived at the physical layer device. The control unit (10) also sends in Buf_Full and Buf_Empty signals to the SRAM (3) for indicating the full status and the empty status respectively. The control unit (10) also outputs Buf_Read and Buf Write signals for controlling the SRAM (3) in reading packet headers and writing packet data. Furthermore, the control unit (10) outputs a FIFO_DIN_SEL signal to control the read selector (5) in choosing the source of packet headers to the header buffers (9) from either the SRAM (3) or the physical layer device (2).

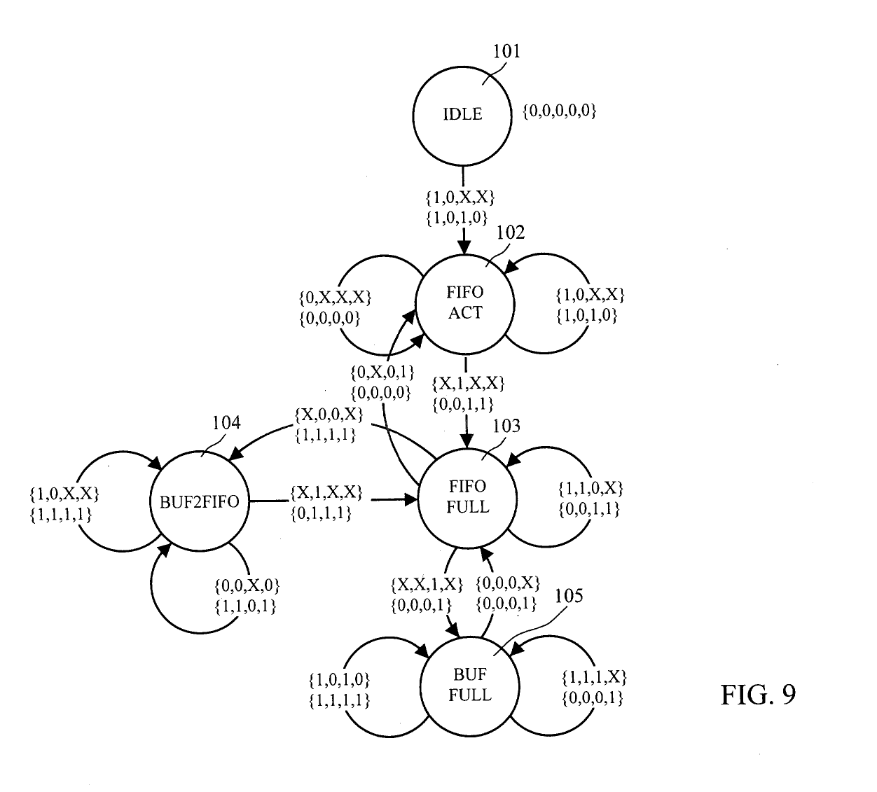

Please refer to FIG. 9 in conjunction FIG. 7 for a state diagram of the control unit. The state diagram has the following input and output signals:

Input={Packet_Arriving, FIFO_Full, Buf_Full, Buf_Empty}

Output={FIFO_Push, Buf_Read, Buf_Write, FIFO_DIN_SEL}

As shown in FIG. 9, the implementation has the following state transitions:

State 101: IDLE

When both the physical layer device (2) and the SRAM (3) are empty and no packets have been received, the control unit (10) inputs {0,0,0,0}. Once packets arrive at the physical layer device (2), the control unit inputs {1,0,X,X} (X: don't care) and transition to state 102 occurs. The control unit (10) will control the read selector (5) in choosing packet headers from the physical layer device (2), make a copy in the header buffers (9), and store the packet data temporarily in SRAM (3). The corresponding output is {1,0,1,0} in this case.

State 102: FIFO ACT

State 102 indicates the operating status of the header buffer (9). When the input is kept as {1,0,X,X}, the control unit (10) controls the read selector (5) in choosing packet headers from the physical layer device (2) and stores the packet headers temporarily in the header buffers (9). At the same time, packet data will be replicated and stored temporarily in the SRAM (3), and then the output signal is {1,0,1,0}. When the input is {0,X,X,X}, it indicates no packets are present and the control unit (10) will remain in state 102, and then the output signal is {0,0,0,0}. When the input is {X,1,X,X}, it indicates the header buffers (9) are full and transition to state 103 occurs. At this time, the output signal is {0,0,1,1}.

State 103 : FIFO FULL

State 103 indicates whether the header buffers (9) are full or not. When the input is {1,1,0,X}, the header buffers (9) are full. Packet data received afterwards will be sent directly to the SRAM (3) with an output of {0,0,1,1}. If the header buffers (9) become unfull after the receiving processor (7) fetches the packet headers, the input would be {X,0,0,X} and transition to state 104 occurs with an output of {1,1,1,1}. This allows packet headers stored in SRAM (3) are sent to the header buffers (9) because the header buffers were previously full. If the SRAM (3) becomes unfull after the packets are processed, the input is {0,X,0,1} and transition to state 102 occurs with an output of {0,0,0,0}. Lastly, if both the header buffers (9) and the SRAM (3) are full, the input would be {X,X,1,X} and transition to state 105 occurs with an output of {0,0,0,1}.

State 104: BUF2 FIFO

After a state transition from state 103 to state 104, the header buffers (9) become unfull and the input is {0,0,X,0}. Since packet headers left in SRAM (3) when header buffers (9) were previously full are processed in priority, the corresponding output is {1,1,0,1}. As a result, packet headers will be sent from the SRAM (3) to the header buffers (9). When new packets arrive at the physical layer device (2) and the header buffers (9) are unfull, the input is {1,0,X,X} and the output of the control unit is {1,1,1,1}. This allows unprocessed packet headers in the SRAM (3) to be stored temporarily in the header buffers (9) and processed in priority. At the same time, packets received by the physical layer device (2) are written into SRAM (3) and the status is kept at State 104. This continues until the header buffers (9) are full again, which produces input and output of {X,1,X,X} and {0,1,1,1} respectively at the control unit (10). Transition to state 103 occurs in this case.

State 105: BUF FULL

State 105 occurs when the SRAM (3) is full. After a state transition from state 103 to state 105, the input is {1,1,1,X} which indicates both the header buffers (9) and the SRAM (3) are full. The control unit (10) will not signal the SRAM (3) to read packet headers and packets received afterwards will be discarded, which means the output is {0,0,0,1}. When the input is {1,0,1,0}, it indicates the SRAM (3) is full but the header buffers (9) are unfull. In this case, when a packet header is transferred from the. SRAM (3) to the header buffers (9), a new packet can be stored in the SRAM (3); therefore, the corresponding output is {1,1,1,1}. When the input is {0,0,0,X}, which indicates the header buffers (9) are unfull and the SRAM (3) becomes unfull after being read, the corresponding output is {0,0,0,1} and transition moves back to state 103. Finally, when the input is {X,X,X,1}, the similar discussion can find that the output is {0,0,0,1}.

The packet transceiving device and method of the present invention provide many advantages and uniqueness. Specifically, the HCA (1) along with a plurality of header buffers can increase the efficiency of packet reading and transferring, which reduces the repetitions in transmission. Another advantage of the invention is the process of packet-switching in a multi-port transmission network. This includes the using of a control unit for dynamically managing the transceiving of packet headers, which leads to an optimal efficiency.

As described above, this invention has many advantages and it resolves problems from conventional prior arts in both practice and application. The proposed methods are effective and can be implemented as a reliable system that achieves originality with great economical value.

Although preferred embodiments are given in detailed description with appropriate figures, it will be apparent to those skilled in the art that the implementation may be altered in many ways without departing from the scope of the invention. Accordingly, the scope of the invention should be determined by the following claims and their legal equivalents.

1. A host channel adapter for receiving a plurality of packets from a packet-switching network, said host channel adapter being coupled to a plurality of physical layer devices, a packet buffer and a local processor, comprising:
a plurality of header buffers for storing a plurality of packet headers of the packets; and
a control unit for monitoring a packet arriving status and a storage status of both the packet buffers and said header buffers, and outputting a control signal to control the transmission of said packet headers.

2. The host channel adapter according to claim 1, said control signal indicating said packet headers directly flowing from the physical layer devices to said head buffers.

3. The host channel adapter according to claim 1, said control signal initially indicating said packet headers directly flowing from the physical layer devices to the packet buffer while said header buffers being full, and then indicating said packet headers directly flowing from the packet buffer to said header buffers while said header buffers being unfull.

4. The host channel adapter according to claim 1, wherein one of said header buffers being chosen from the group consisting of the following: static random access units, latches, or flip-flops.

5. The host channel adapter according to claim 1, wherein one of said header buffers has a FIFO architecture.

6. The host channel adapter according to claim 1, wherein a read selector is included for choosing the source of said packet headers stored in said header buffers directly from the physical layer device or directly from the packet buffer depending on said control signal.

7. The host channel adapter according to claim 1, wherein one of said packet buffers is a static random access memory (SRAM).

8. The host channel adapter according to claim 1, wherein said control unit handling whether the physical layer devices receive the packets by accepting a Packet_Arriving signal.

9. The host channel adapter according to claim 1, wherein the control unit handling whether the packet buffer is full or empty by accepting respectively a Buf_Full signal and a Buf_Empty signal.

10. The host channel adapter according to claim 1, the control unit outputs both a Buf_Read signal and a Buf_Write signal for controlling both the actions of reading said packet headers from the packet buffer to said header buffers and the action of writing the packet to said packet buffers respectively.

11. The host channel adapter according to claim 1, said head buffers outputting stored said packet headers to said local processor.

12. A host channel adapter coupled to a plurality of physical layer devices for receiving a plurality of packets from a packet-switching network, said host channel adapter being coupled to a packet buffer, comprising:
a plurality of header buffers used to store a plurality of packet headers of the packets,
said header buffers being coupled with said physical layer devices and said packet buffer, moreover, the packets being stored temporarily in the packet buffer and the packet headers being selectively stored in said header buffers.

13. The host channel adapter according to claim 12, wherein one of said header buffers being chosen from the group consisting of the following: static random access units, latches, or flip-flops.

14. The host channel adapter according to claim 12, wherein one of said packet buffers is a static random access memory (SRAM).

15. A method for receiving packets from a packet-switching network, comprising the steps of:
receiving a plurality of packets with a plurality of corresponding packet headers; and
replicating and storing said packet headers in a header buffer until said header buff is full, and storing said packets in a memory.

16. The method according to claim 15, further comprising the step of moving portions of said packet headers stored in said memory into said header buffer after said header buffer is unfull for at least one stored said packet headers being processed.

17. The method according to claim 15, further comprising the step of monitoring a packet arriving status and a storage status of both said memory and said header buffer, and then generating a corresponding control signal.

18. The method according to claim 17, said control signal being used to indicate said packet headers directly flowing from the packet-switching network to said head buffer.

19. The method according to claim 17, said control signal being used to initially indicate said packet headers directly flowing from the packet-switching network to said memory while said header buffer being full, and then being used to indicate said packet headers directly flowing said the memory to said header buffer while said header buffers being unfull later.

20. The method according to claim 15, further comprising the step of discarding the packets when said memory is full.
